(19) United States
(12) Patent Application Publication
(10) Pub. No.: US 2022/0227615 A1
(43) Pub. Date: Jul. 21, 2022

(54) VERTICAL BOTTLE OPENER APPARATUS HAVING OPENER FORMED ON LOWER PORTION OF HANDLE

(71) Applicant: Hae Sik SEO, Suwon-si (KR)

(72) Inventor: Hae Sik SEO, Suwon-si (KR)

(21) Appl. No.: 17/611,223

(22) PCT Filed: Jun. 15, 2020
(86) PCT No.: PCT/KR2020/007710

§ 371 Date: Nov. 15, 2021

(30) Foreign Application Priority Data
Jun. 14, 2019 (KR) 10-2019-0070969

(51) Int. Cl. B67B 7/16

(52) U.S. Cl. CPC B67B 7/16

(57) ABSTRACT

The present invention includes a vertical bottle opener apparatus capable of easily separating a bottle cap from a bottle, the vertical bottle opener apparatus comprising: a body including an inner space and injection-molded to serve as a handle, and an opener integrally formed on a lower portion of the body and including a metal plate separating the bottle cap from the bottle. Therefore, the present invention provides an effect that the bottle cap can be easily separated from the bottle only with the wrist snap, using the opener having the metal plate that is integrally formed on the lower portion of the body.

### FIELD OF THE INVENTION

The present invention relates to a vertical bottle opener, and more particularly, to a vertical bottle opener apparatus in which an opener is formed on the lower portion of the handle, thereby separating a bottle cap from a bottle only with a wrist snap.

### BACKGROUND OF THE INVENTION

In general, a bottle opener is a tool used to separate a bottle cap from a bottle. As shown in FIG. 1, a conventional bottle opener includes a body 10 serving as a handle and an opener separating a bottle cap from a bottle, which are formed horizontally.

In this instance, the conventional bottle opener has to be operated by moving the body 10 in a vertical direction to separate the bottle cap from the bottle. Since a user's arm must be moved to operate the body 10 in the vertical direction, there is an inconvenience in using the bottle opener.

A bottle opener structure of Korean Registration Utility Model No. 20-0193706 consists of a body and a cover in which an opener hook is formed on the opening thereof, and separates the bottle cap from the bottle using this structure.

However, the bottle opener above is inconvenient because a user must move his or her arm to separate the bottle cap from the bottle.

The bottle opener structure of Korean Registration Utility Model No. 20-0437055 consists of a case and a body fixed to a coupling groove of the case and having a hook piece and a push piece which are formed by both ends of the body that are bent to face to each other, and separates the bottle cap from the bottle using this structure.

However, the bottle opener has low durability because the main body having the hook piece and the push piece is separately formed from the case.

### DETAILED DESCRIPTION OF THE INVENTION

### Technical Problems

In order to solve the problems above, an object of the present invention is to provide a bottle opener apparatus capable of easily separating a bottle cap only with the wrist snap.

In addition, an object of the present invention is to provide a bottle opener apparatus capable of increasing the effect of advertisement exposure.

Another object of the present invention is to provide a bottle opener apparatus capable of functioning as a bottle cap.

Another object of the present invention is to provide a bottle opener apparatus capable of improving durability.

Another object of the present invention is to provide a bottle opener apparatus capable of improving user convenience.

### SUMMARY OF THE INVENTION

To achieve the objects above, the prevent invention provides a vertical bottle opener apparatus capable of easily separating a bottle cap from a bottle, the vertical bottle opener apparatus comprising: a body including an inner space and injection-molded to serve as a handle, and an opener integrally formed on a lower portion of the body and including a metal plate separating the bottle cap from the bottle.

The body of the present invention includes an outer side wall on which a logo or text for advertisement is printed.

The body of the present invention includes a fixing part to fix the opener, and the fixing part is engaged with or forcedly inserted with an edge of the opener at a lower portion of an inner side wall of the body and forms an integral structure with the opener.

The present invention further comprises a cover that is detachably installed on a top end of the body, wherein the cover is made of soft material, and is a structure that can seal the bottle by being mounted on an opening of the bottle in a state that the bottle cap is separated therefrom.

The opener of the present invention includes: an opening into which the bottle cap is inserted, and a first opener piece and a second opener piece, each of which protrudes toward a center of the opening from facing position insides the metal plate.

### TECHNICAL EFFECTS OF THE INVENTION

As described above, the present invention provides an effect that the bottle cap can be easily separated from a bottle only with the wrist snap, using an opener having a metal plate that is integrally formed on the lower portion of the body.

In addition, the present invention provides an effect of increasing the advertisement exposure using a logo or text printed on the side wall part for advertisement.

In addition, the present invention provides an effect of improving the durability of the bottle opener with a fixing part, which is engaged with or forcedly inserted with the edge of the opener at the lower portion of the inner wall thereof.

In addition, the present invention provides an effect of improving the user convenience with a cover to seal the bottle from which the bottle cap is separated.

In addition, the present invention provides the effect of improving the user convenience with a plurality of opener pieces for bidirectional use.

In addition, the present invention provides an effect of improving the durability of the bottle opener with a plurality of opener pieces which are connected to each other and form an integral structure.

In addition, the present invention provides an effect of improving the user convenience with the mechanism that the separated bottle cap is inserted into the inner space through the opening only by the user's separating operation.

### BRIEF DESCRIPTION OF THE DRAWINGS

FIG. 1 is a schematic drawing illustrating a conventional bottle opener structure.

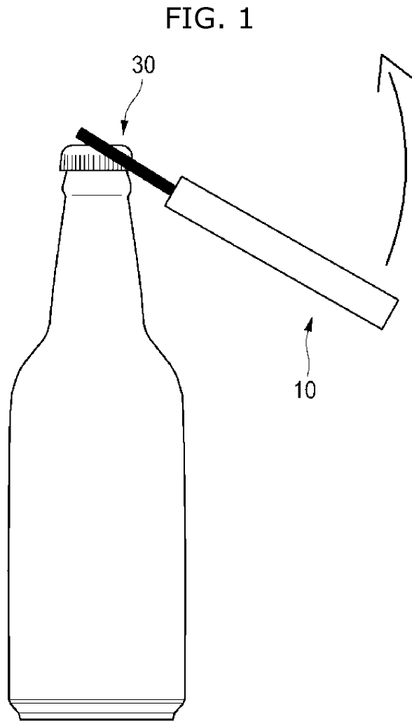

FIG. 2 is a schematic drawing illustrating a vertical bottle opener apparatus according to one embodiment of the present invention.

FIG. 3 is a side view illustrating a vertical bottle opener apparatus according to one embodiment of the present invention.

FIG. 4 is a bottom view illustrating a vertical bottle opener apparatus according to one embodiment of the present invention.

FIG. 5 is a top view illustrating a vertical bottle opener apparatus according to one embodiment of the present invention.

FIG. 6 is a schematic drawing illustrating a vertical bottle opener apparatus according to another embodiment of the present invention.

### DESCRIPTION OF REFERENCE NUMBER OF MAIN PART

100: Body
110: Side Wall Part
111: Inner Space
112: Outer Side Wall
113: Inner Side wall
120: Fixing Part
200: Cover
210: Elastic Part
300: Opener
310: Opening
320: Opener Piece
321: First Opener Piece
322: Second Opener Piece

### BEST MODE FOR THE INVENTION

Hereinafter, preferred embodiments of the present invention will be described in more detail in conjunction with the accompanying drawings.

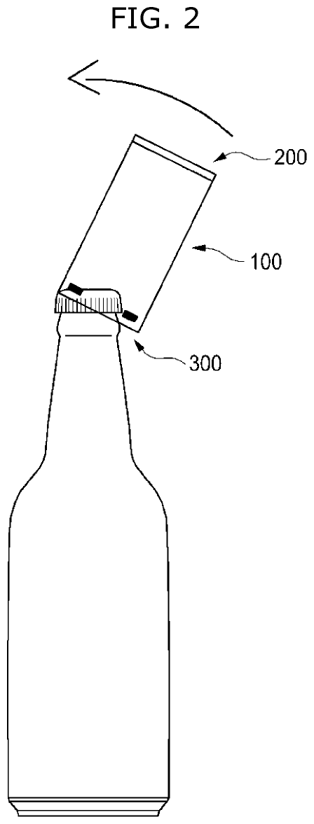

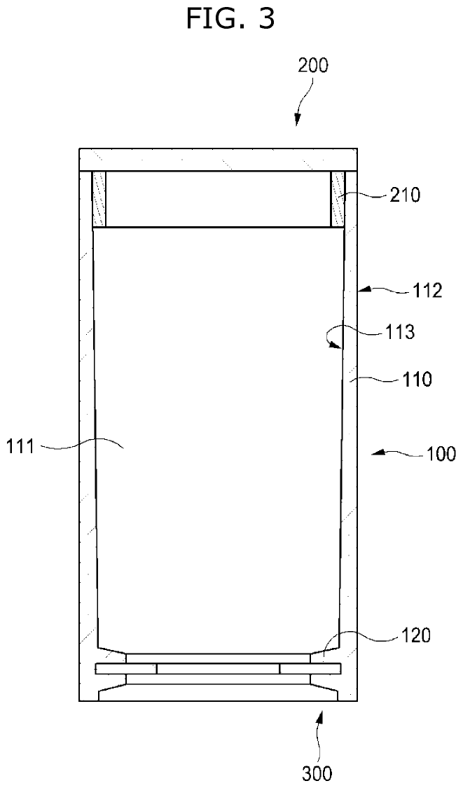

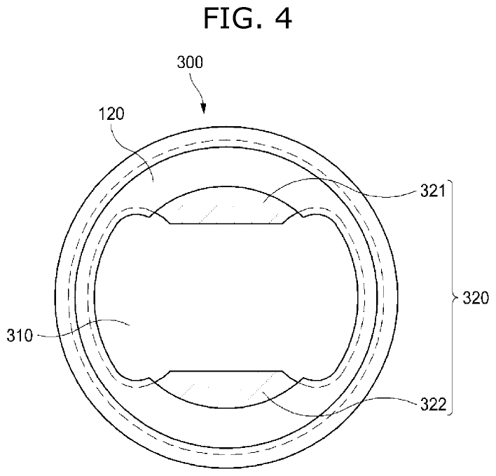

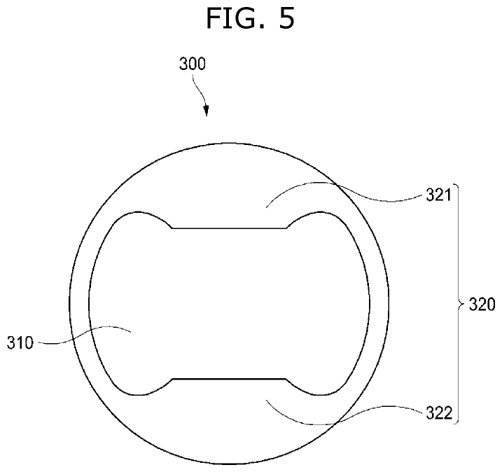

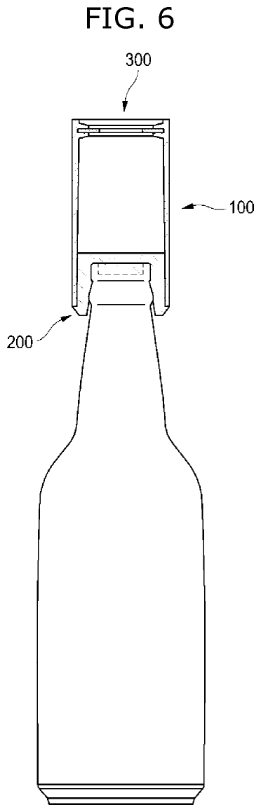

FIG. 2 is a schematic drawing illustrating a vertical bottle opener apparatus according to one embodiment of the present invention. FIG. 3 is a side view illustrating a vertical bottle opener apparatus according to one embodiment of the present invention. FIG. 4 is a bottom view illustrating a vertical bottle opener apparatus according to one embodiment of the present invention. FIG. 5 is a top view illustrating a vertical bottle opener apparatus according to one embodiment of the present invention. FIG. 6 is a schematic drawing illustrating a vertical bottle opener apparatus according to another embodiment of the present invention.

As shown in FIGS. 2 to 6, a vertical bottle opener apparatus according to this embodiment comprises a body 100, a cover 200, and an opener 300. The opener 300 of the vertical bottle opener apparatus is formed on the lower portion of handle thereof, thereby enabling a bottle cap to be easily separated from a bottle only with a user's wrist snap.

The body 100 may be made of plastic injection-molded to serve as a handle for a user to easily grip the bottle opener. The body 100 includes an inner space 111, a side wall part 110, and a fixing part 120.

The body 100 may be formed in various shapes, such as a beverage can shape, a cylindrical shape, a square column shape, and the like.

The side wall part 110 has the inner space 111 therein, and the thickness of the side wall part 110 increases as it goes from the top to the bottom. Preferably, the inner wall 113 of the side wall part 110 is formed in a tapered shape so that the inner space 111 is reduced as it goes from the top to the bottom. Accordingly, this structure increases the strength of the fixing part 120 formed at the lower portion of the side wall part 110.

In addition, since a logo or text for advertisement is printed on an outer side wall 112 of the side wall part 110, the advertisement exposure effect can be increased when the vertical bottle opener apparatus is displayed or used in an upright position.

The inner space 111 may store the bottle cap separated from the bottle by the opener 300 and inserted therein. The stored bottle caps may be discharged by opening the cover 200.

The fixing part 120 is a part for fixing the circumference of the opener 300 to the lower portion of the body 100. The fixing part 120 protrudes from the inner circumferential surface of the lower portion of the inner side wall 113 toward the center of the opener 300, and is engaged with or forcedly inserted with the edge of at least one of the top and bottom side of the opener 300, thereby forming an integral structure with the opener 300.

Since the fixing part 120 is formed that the thickness thereof increases as it goes from the center of the opener 300 to the inner side wall 113, this structure can increase the strength of the fixing part 120 for fixing and supporting the opener 300.

The cover 200 is a part that is detachably installed on the top end of the body 100 and includes an elastic part 210 fitted into the tapered inner side wall 113 using an elastic force.

The elastic part 210 is protruded and extended from the cover 200 to be fitted into the tapered inner side wall 113 and pressurized to install the cover 200 to the body 100.

In addition, as shown in FIG. 6, the cover 200 is a sealing means to seal the bottle to prevent leak of contents contained in the bottle. The cover 200 is made of soft material such as silicone or soft plastic, and mounted on the opening of the bottle cap-separated bottle to seal the bottle.

The cover 200 improves user convenience because the bottle opener can be used as a bottle cap without using a separate apparatus.

The opener 300 is an opening means made of a metal plate, which separates the bottle cap from the bottle. As shown in FIG. 4, the opener 300 includes an opening 310 and an opener piece 320, and the opening 310 and a portion of the opener piece 320 are exposed to the outside, the remaining portion is engaged with or forcedly inserted to the fixing part 120, and covered by the fixing part 120 so as not to be exposed to the outside. In FIG. 4, the outer dashed line is the outer circumference of the opener 300, and the inner dashed line is the inner circumference of the opener 300.

The opening 310 is a part into which the bottle cap is inserted, and enables the metal plate of the opener 300 to separate the bottle cap from the bottle. The opening 310 has a shape corresponding to the size of the bottle cap, and is formed to enable the bottle cap separated by the opener 300 to be inserted into the inner space 111.

The opener piece 320 separates the bottle cap from the bottle when the bottle cap is caught. The opener piece 320 includes a first opener piece 321 and a second opener piece 322, each of which protrudes toward the center of the opening 310 from the opposite position inside the metal plate.

The first opener piece 321 and the second opener piece 322 are connected to each other and formed in an integrated structure. Since the first opener piece 321 and the second opener piece 322 are engaged with or forcedly inserted to the fixing part 120, and integrated with the fixing part 120, the durability of the bottle opener is improved.

When any one of the first opener piece 321 and the second opener piece 322 is caught on one end of the bottle cap, the other one supports the other end of the bottle cap, and thus, the bottle cap can be separated from the bottle. Therefore, since the vertical bottle opener apparatus can be used in both directions, the user convenience can be improved.

In addition, the bottle cap is inserted into the inner space 111 through the opening 310 and stored only by the separating operation of the bottle cap. Therefore, the user does not need to cope with or collect it again, which can increase user convenience.

The present invention described above can be embodied in various other forms without departing from the technical idea or main features thereof. Accordingly, the above embodiments are merely examples in all respects and should not be construed as limiting the present invention.

### INDUSTRIAL APPLICABILITY

The present invention provides a vertical bottle opener apparatus in which the opener is formed on the lower portion of the handle, thereby separating a bottle cap from a bottle only with the wrist snap.

What is claimed is:

1. A vertical bottle opener apparatus capable of easily separating a bottle cap from a bottle, the vertical bottle opener apparatus comprising:
a body including an inner space and injection-molded to serve as a handle, and
an opener integrally formed on a lower portion of the body and including a metal plate separating the bottle cap from the bottle.

2. The vertical bottle opener apparatus of claim 1, wherein the body includes an outer side wall on which a logo or text for advertisement is printed.

3. The vertical bottle opener apparatus of claim 1, wherein the body includes a fixing part to fix the opener, and the fixing part is engaged with or forcedly inserted with an edge of the opener at a lower portion of an inner side wall of the body and forms an integral structure with the opener.

4. The vertical bottle opener apparatus of claim 1, further comprising a cover that is detachably installed on a top end of the body,
wherein the cover is made of soft material, and is a structure that can seal the bottle by being mounted on an opening of the bottle in a state that the bottle cap is separated therefrom.

5. The vertical bottle opener apparatus of claim 1, wherein the opener includes:
an opening into which the bottle cap is inserted, and
a first opener piece and a second opener piece, each of which protrudes toward a center of the opening from facing position insides the metal plate.
